(19) United States
(12) Patent Application Publication
(10) Pub. No.: US 2005/0061197 A1
(43) Pub. Date: Mar. 24, 2005

(54) Control of biofilms in industrial water systems

(76) Inventor: Christopher J. Nalepa, Zachary, LA (US)

Correspondence Address: Edgar E Spielman Jr;Patent & Trademark Division, Allbemarle Corporation, 451 Florida Street, Baton Rouge, LA, 70801-1765, US

(21) Appl. No.: 10/492,073

(22) PCT Filed: Oct. 9, 2002
(86) PCT No.: PCT/US02/32300

(30) Foreign Application Priority Data
Oct. 9, 2001 (US) 60328384

(51) Int. Cl. C09D 5/14

(52) U.S. Cl. 106/15.05

(57) ABSTRACT

The effectiveness of a bromine-based biocide in combating formation of biofilm infestation and/or growth of biofilm on a surface is potentiated by use therewith of a biodispersant. The biocide is a bromine based-biocide comprising (i) a sulfamate-stabilized, bromine-based biocide or (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii).

### TECHNICAL FIELD

This invention relates to improving the performance of certain biocides in the eradication or at least effective control of biofilms.

### BACKGROUND

Clean system surfaces are critical to the efficient operation and maintenance of heat rejection devices such as recirculating cooling systems. The art and science of water treatment focuses on the economical control of scales, deposits, corrosion products, and microorganisms throughout the cooling system. The build-up of these surface contaminants can give rise to an avalanche of problems—poor heat transfer, high energy consumption, film fill pluggage, increased maintenance expenditures, short system life, high overall operating costs, etc.

Microorganisms attached to surfaces, commonly known as biofilms, contribute to many of these problems. Some of the problems posed by biofilms in industrial water systems include the following:
A) Biofilm deposits are effective thermal insulators. One prior study found the thermal conductivity of a biofilm to be 25% that of a calcium carbonate scale of equivalent thickness. This results in decreased heat transfer and increased energy consumption.
B) Biofilm deposits are a critical factor in film fill fouling. High efficiency film fills, which are prone to fouling, were introduced in the 1970's and 1980's. In one prior study, the combination of biofouling and silt led to an “astounding” weight gain of 14.8 Ibs/cu ft of film fill in 42 days. Silt-only treatment provided little weight gain (2.3 Ib/cu ft) within the same time frame. The authors of that study concluded that “silt alone does not appear capable of [film fill] failure plugging.”
C) Biofilm deposits increase corrosion of metallurgy. The colonization of surfaces by microorganisms and the products associated with microbial metabolic processes create environments that differ greatly from the bulk solution. Low oxygen environments at the biofilm/substrate surface, for example, provide conditions where highly destructive anaerobic organisms such as sulfate reducing bacteria can thrive. This leads to MIC (microbially induced corrosion), a particularly insidious form of corrosion which, according to one published report, can result in localized, pitting corrosion rates 1000-fold higher than that experienced for the rest of the system. In extreme cases, MIC leads to perforations, equipment failure, and expensive reconditioning operations within a short period of time. For example, it has been indicated that in a newly-build university library without an effective microbiological control program sections of the cooling system pipework had to be replaced after just one year of service due to accumulations of sludge, slime, and SRBs.
D) Perhaps the greatest problem associated with biofilms is health related. It is known that biofilms can create an environment for Legionella pneumophila, the bacterium species responsible for Legionnaires' disease, to thrive. This bacterium has been reported to be capable of attaining high risk levels in man-made water systems such as cooling towers and evaporative condensers, whirlpool spas and baths, domestic hot water/shower systems, and grocery misters. Deadly outbreaks of Legionnaires' disease continue to take place with regularity despite a growing list of published guidelines and recommended practices by AWT, CTI and other industry groups and governmental agencies. For example, in April, 2000 a large outbreak occurred in Australia in a new facility that was commissioned just 3½ months before. This outbreak has been reported to have resulted in 101 confirmed cases of Legionnaire's disease and 2 deaths.

Biofilms are clearly the direct cause or potentiators for many cooling system problems. Several years ago, the economic impact of biofilms in the US alone was estimated at $60 billion dollars.

Biofilms are a collection of microorganisms attached to a surface, the metabolic products they produce, and associated entrained debris (silt, scale, iron, etc.).

Initial colonization of a surface takes place when an organism present in the bulk water such as Pseudomonas aeruginosa—a common slime-forming bacteria in industrial water systems—adheres to a surface. This change in state from free-swimming/planktonic state to attached/sessile state causes a dramatic transformation in the microorganism. Genes associated with the planktonic state turn off; genes associated with the sessile state turn on. Typically the microorganism loses appendages associated with the free swimming state, such as flagella, and obtains appendages more appropriate for the present situation, such as short, hair-like pillea which afford numerous points for attachment. The attachment process further stimulates production of slimy, polysaccharide (starch-like) materials generally termed extracellular polymeric substances (EPS). Given proper conditions, more bacteria attach to the surface. Eventually the surface is covered with a layer of attached bacteria and associated EPS.

If this was all that takes place, biofilms might be relatively easy to control. However, bacteria continue to colonize the surface building up to several and even hundreds of cell layers thick. Recent scientific evidence indicates that this colonization process proceeds with a high degree of order. Cells within the developing microcolony communicate with one another using a signaling mechanism termed quorum sensing. The individual cells constantly produce small amounts of chemical signals. When these signals reach a certain concentration, they modify the behavior of the cells and result, for example, in the creation of water channels. The water channels enable the transport of nutrients into the colony and the removal of waste products from the colony.

Soon other microorganisms find niches within the microcolony suitable for growth. Low oxygen or anaerobic conditions at the substrate/microcolony surface prove inviting for destructive microorganisms such as sulfate-reducing bacteria (SRBs). Protozoa and other amoebae welcome the opportunity to graze on the sessile bacterial community. Legionella pneumophila and/or other pathogenic organisms find suitable niches to reproduce and thrive. The fully developed microcolony thus contains a variety of chemical gradients and consists of a consortia of microorganisms of differing types and metabolic states.

Eventually conditions within the microcolony may not be ideal for some or all of the microorganisms present. The microorganisms detach, enter the bulk water, and search for other colonization sites. It has been recently been discovered that, as in the case for creation of water channels within the developing biofilm, certain chemical signals govern the detachment process as well.

The microorganisms present in the biofilm typically exhibit reduced susceptibility to biocides. In other words, once established, biofilms can be persistent and difficult to get rid of. This is due to a number of factors:
1) Reduced Penetration. Biofilms used to be viewed as offering an impenetrable barrier by virtue of the layer of EPS surrounding the attached organisms. This view has since been modified slightly with the discovery of water channels—in effect a primitive circulatory system—throughout the biofilm. The current view is that although many substances such as chloride ion, for example, enjoy ready access into the interior of the biofilm, reactive substances such as chlorine or other oxidizing biocides can be deactivated via reaction with EPS at the biofilm surface. For example, a paper on studies of 7-day biofilms challenged with 5 ppm chlorine indicates that chlorine levels were only 20% that of the bulk water in the biofilm interior. Organisms within the biofilm are thus exposed to reduced amounts of biocide.
2) Intrinsic Resistance. Biofilm organisms exhibit vastly different characteristic than their planktonic counterparts. For example, a paper published in 1997 shows that even one-day biofilms indicate a much-reduced susceptibility to antibiotics relative to their planktonic counterparts—often requiring a 1000-fold increase in antibiotic dose for complete deactivation of the biofilm
3) Microbiological Diversity. Biofilms offer many different microniches—oxygen rich areas, oxygen depleted areas, areas of relatively high pH, areas of low pH, etc. These wide-ranging environments lead to diversity in types of organisms and metabolic activity. Cells near the bulk water/biofilm surface, for example, respire and are reported to grow at a greater rate than those within the interior of the biofilm which may be essentially dormant These dormant cells are less susceptible to biocide treatment and can repopulate the biofilm rapidly when conditions are favorable.

Factors that promote biofilm development include the following:

a) Substrate and Temperature.

Although not often under the control of the water treater, substrate and temperature can dramatically impact biofilm development. A paper published in 1994 reports on studies on the effect of substrate and temperature on colonization by biofilm bacteria and biofilm-associated Legionella over a period of 1-21 days. Colonization proved greatest on plastic surfaces (cPVC, polybutylene) compared to copper at all temperatures. Colonization was consistently high on the plastic surfaces at all temperatures except 60° C. where counts dropped off by 1-2 log units. Legionella counts were greatest on all surfaces at 40° C. with no Legionella detected at 60° C. L. pneumophila represented a low percentage of the microbial population of the plastic surfaces at 20° C. (0.1%) but this increased greatly (10-20%) at 40° C. Interestingly, copper inhibited colonization by L. pneumophila as this organism was only detected at 40° C. where it represented 2% of the total bacterial population.

In another study, 48-hour biofilms were grown on galvanized iron, glass, and PVC. Biofilm counts on the plastic surface (˜10⁸ CFUs/cm²) were about 1 log count higher than on the other surfaces. The action of certain oxidizing biocides, viz., chlorine, bromine, and N,N′-bromochloro-5,5-dimethylhydantoin (BCDMH) proved to be greatest on galvanized iron and least on PVC. The authors concluded that “PVC surfaces are problematic by supporting biofilm colonization, disinfection resistance, and regrowth.”

In another study, populations of 21-day old biofilms were about 1 log greater when grown on mild steel (5.5 to 6.8 log CFU/cm²) than stainless steel (4.7 to 5.8 CFU/cm²). Dosages of BCDMH (1 mg/L free residual) reduced biofilm counts by 1.4 logs on mild steel and 2.0 logs on stainless steel at 30° C. Legionella pneumophila represented 1-10% of the total population of the biofilms. However, no viable Legionella were recovered from the biofilms on either metal surface upon exposure to biocide (1 mg/L BCD) for 24 hours.

Results of studies in a model cooling tower on the effect of temperature (30-40° C.) on biofilm bacteria, biofilm protein, and biofilm carbohydrate on stainless steel surfaces has been reported. Analysis after 14 days showed that control populations of biofilm bacteria were greatest at 40° C. and that the amount of biofilm protein and carbohydrate produced were greatest at 35° C. The largest portion of the biomass on a weight basis was carbohydrate and this represented about 4 times that of protein. The relatively high amount of carbohydrate (representative of EPS) indicates the extent to which biofilm bacteria can produce slime in cooling systems. Biocide studies under high nutrient conditions using 3 ppm isothiazolone (3 ppm a.i., dosed 3× per week) indicated good control of heat transfer resistance and biofilm carbohydrate. However, viable cell counts with the biocide were equivalent to that of control.

The preceding studies indicate that colonization by biofilm bacteria is generally greatest on plastic surfaces and least on copper surfaces. Colonization of mild steel and stainless steel appears to be an intermediate case with stainless steel less colonized than mild steel. The optimum temperature for colonization by biofilm bacteria and biofilm-associated Legionella appears to lie in the range of 30-40° C. At these temperatures Legionella can colonize plastic and steel surfaces in numbers representing up to 20% of the total microbial population an production of biofilm slime is at its peak. These studies support problems associated with fouling of film fills which are typically made of plastic such as PVC. They also suggest that systems containing substantial amounts of copper pipework may be less prone to biofilm-related problems.

b) Flow Rate and Temperature

The impact of peracetic acid/hydrogen peroxide on biofilms grown on 304 stainless steel disks was reported in 1998. Biofilms grown under flow conditions were 3 times more sensitive to the biocide than those grown statically (concentration for 2 log kill ˜25 ppm (flow); 80 ppm (static)). Decreased biocide efficacy under static conditions was explained by occurrence of stagnation and starvation effects in the biofilm (microbiological diversity) and production of more copious amounts of extracellular polymer (reduced biocide penetration).

High flow rates dramatically boosted biocide activity. Up to a six-log increase in disinfection was obtained under turbulent flow vs. static conditions. This increase was attributed to improved mass transport of disinfectant into biofilm cells (increased biocide penetration). Temperature increased biocide activity as well. Efficacy jumped more than 3-logs in going from 20 to 50° C.

In another study, an increase in flow rate improved biofilm removal on 3-day biofilms treated with 50 ppm glutaraldehyde. Interestingly, the authors point out that low levels of glutaraldehyde had little effect on biofilm removal with a “no effect” level of 20 ppm. This was thought to be due to crosslinking of the glutaraldehyde with the outer surface of the cells effectively preventing penetration into the biofilm.

These studies indicate that biofilms grown under static or low flow conditions can be inherently more difficult to control. Such low flow, stagnant areas may occur in water systems in parts of the distribution deck, cooling tower sump, and in system dead legs. These studies further indicate that higher temperatures and increased flow rates can increase the susceptibility of biofilms towards biocides. The former effect may be due to an increase in microbial metabolic activity at the higher temperature; the latter due to increased biocide penetration into the biofilm.

Among disclosed research efforts directed to control of biofilms with biocides are the following:

Hypochlorous acid, hypobromous acid, and the halogen donor BrMEH (bromo-chloro-methylethylhydantoin) were tested against bio films of Sphaerotilus natans (M. L. Ludensky and F. J. Himpler, “The Effect of Halogenated Hydantoins on Bioflirs,” paper no. 405, Corrosion/97, NACE International, Houston, Tex., 1997). Note that S. Natans forms robust, filamentaceous biofilms that are very resistant to biocidal treatment. Dynamic tests using non-destructive biofilm monitoring techniques (heat transfer resistance and dissolved oxygen concentration) indicated biofilm control (but not eradication) at the following treatment levels: 10 ppm BrMEH, 15 ppm HOBr, and >20 ppm HOCl (i.e., chlorine did not control the biofilm at the maximum applied dose of 20 ppm). Both bromine itself and the bromine donor BrMEH (bromochloromethylethylhydantoin) thus appeared more effective than chlorine in these tests.

A recent study compared the efficacy of hydantoin products (BCDMH, BrMEH) towards both planktonic and biofilm bacteria (J. F. Kramer, “Biofilm Control with Bromo-Chloro-Dimethyl-Hydantoin,” paper no. 01277, NACE International, Houston, Tex., 2000). Biofilm studies were carried out on 5-to 7-day biofilms generated on stainless steel cylinders grown in a laboratory flow-through system. Both products dosed at 0.5 ppm (total residual as Cl₂) gave >4 log reductions in planktonic organisms after 1 hour. As expected, efficacy decreased against biofilm bacteria. At 1 ppm residuals, BCDMH provided only a 1 log kill; BrMEH a 0.7 log kill. Efficacy of both products towards biofilm bacteria improved slightly in the presence of ammonia. CT (concentration vs. time) studies suggest that it may be better to dose a lesser amount of product for a longer period of time.

Chlorine dioxide has been shown to control biofilms. For example, 1.5 mg/L ClO₂ applied continuously for 18 hours in a flow-through system reduced biofilm bacteria 99.4%, (J. Walker and M. Morales, “Evaluation of Chlorine Dioxide (ClO₂) for the Control of Biofilms,” Water Science and Technology, vol. 35, no. 11-12, pp. 319-323 (1997)). A recent field trial indicated effective biofouling control at an applied dose of 0.1 mg/L, (G. D. Simpson and J. R. Miller, “Control of Biofilm with Chlorine Dioxide,” paper presented at the AWT Annual Convention, Honolulu, Hi., 2000).

Field studies were reported concerning a newly-registered combination of peracetic acid (5.1% w/w) and hydrogen peroxide (21.7% w/w) for cooling water treatment, (J. Kramer, “Peroxygen-Based Biocides for Cooling Water Applications,” presented at AWT Annual Meeting, Traverse City, Mich., 1997). This biocide combination dosed every other day to a residual of about 10 ppm PAA and 40 ppm hydrogen peroxide (0.6 gallons/dose) provided effective control of sessile bacteria. Biofilm counts were about 1.5 to 2.5 logs vs. 2.5 to 4 logs for isothiazolone (5 gals, once/wk., ˜20 ppma.i.). Recommended application rates ranged from 5-9 ppm PAA 2 to 3 times per week (fouled system) to 3-5 ppm PAA 2 to 3 times per week (clean system). It was suggested to alternate application of PAA with halogen-based biocides.

The performance of hydrogen peroxide and other biocides were investigated in a pilot cooling system at pH 9, (M. F. Coughlin and L. Steimel, “Performance of Hydrogen Peroxide as a Cooling Water Biocide and its Compatibility with Other Cooling Water Inhibitors,” paper no. 397, Corrosion/97, NACE International, Houston, Tex., 1997. Hydrogen peroxide at 2-3 ppm continuous as well as glutaraldehyde or THPS dosed to 50 ppm yielded 2-log reductions in sessile bacteria counts. A continuous chlorine residual of 0.4 ppm provided a 5-log reduction in biofilm counts (to about 102 bacteria/in²).

A biofouling study was reported with hydrogen peroxide in a once-through cooling system. (J. F. Kramer, “Peracetic Acid: A New Biocide for Industrial Water Applications,” paper no. 404, Corrosion/97, NACE International, Houston, Tex.) Levels of 5 ppm hydrogen peroxide provided better control than 0.1 ppm chlorine. The biocides were dosed for 2 hours/day.

Legionella pneumophila often thrives in sessile microbial communities. A review of control strategies for this problem microorganism was presented in 1999. (G. D. Simpson and J. R. Miller, “Chemical Control of Legionella,” paper presented at the AWT Annual Convention, Palm Springs, Calif., 1999.) A study of the effect of biocides on biofilms containing Pseudomonas species, Legionella pneumophila, and amoebae in pilot cooling towers was also described in 1999. (W. M. Thomas, J. Eccles, and C. Fricker, “Laboratory Observations of Biocide Efficiency against Legionella in Model Cooling Tower Systems,” paper SE-99-3-4, ASHRAE Transactions (1999.) This work indicated that chlorine (0-5 ppm residual) and bromine (0-2 ppm residual) effectively controlled biofilm bacteria over a 4-day period (the duration of the experiment) with about 4 and 3 log reductions, respectively. Halogen residuals varied widely but never exceeded 5 ppm for chlorine and 2 ppm for bromine. Non-oxidizing biocides were not as effective in these tests with polyquat having essentially no effect on biofilm bacteria. Some of the biocides proved more effective at controlling biofilm-associated Legionella. For example, in addition to chlorine and bromine, both dibromonitrilopropionamide (DBNPA) and glutaraldehyde reduced biofilm-associated Legionella to non detectable levels. Both polyquat and ozone treatments did not appear to significantly affect levels of biofilm-associated Legionella.

Results of an investigation of the efficacy of five different biocides on two-week old biofilms consisting of a consortium of Legionella, heterotrophic bacteria and amoebae have been reported. (E. McCall, J. E. Stout, V. L. Yu, and R. Vidic, “Efficacy of Biocides against Biofilm-Associated Legionella in a Model System,” paper no. IWC 99-70, International Water Conference, Engineers Society of W. Pennsylvania, Pittsburgh, Pa., 1999.) The biocide contact time was 48 hours. Chlorine levels of 2 to 4 ppm provided rapid reductions in both biofilm-associated heterotophic bacteria and biofilm-associated Legionella. BCDMH at 10 ppm was also effective but was slower acting. Glutaraldehyde was effective when dosed at 100 ppm active. Carbamate and polyquat were least effective.

Another study has demonstrated that certain biocides offer enhanced long-term control of biofilm organisms. A stabilized bromine product provided longer term control of MIC than either sodium hypochlorite or sodium hypobromite. (M. Ensign and B. Yang, “Effective use of Biocide for MIC Control in Cooling Water Systems,” paper no. 00384, Corrosion/2001, NACE International, Houston, Tex., 2000.) A patented localized corrosion technique was used to measure effects of different biocide treatment regimens in both laboratory and pilot plant cooling tower systems.

In general, most of the biofilm work to date indicates oxidizing biocides such as chlorine and bromine are more effective against biofilm bacteria and biofilm-associated Legionella than other biocides. Biofilm-associated Legionella exhibits enhanced susceptibility to biocide treatment and some non-oxidizing biocides, glutaraldehyde and DBNPA, appear effective in this case. Certain non-oxidizing biocides such as polyquat have not been shown to control biofilm bacteria or biofilm-associated Legionella. Use of such biocides should only be used in combination with other more effective biocides for control of biofilm-related problems. Recent studies indicate that biocides exhibit differences not only in terms of initial efficacy but in terms of the length of recovery of biofilms after biocide application.

Papers suggesting improved control of biofilm organisms by using combinations of biocides have also appeared. In one study, biofilms of Sphaerotilus natans in a laboratory flow through system were treated with combinations of isothiazolone and brominated hydantoin (BrMEH). (M. L. Ludensky, F. J. Himpler, and P. G. Weeny, “Control of Biofilms with Cooling Water Biocides,” paper no. 522, Corrosion/98, NACE International, Houston, Tex., 1998.) The combination of initial application of isothiazolone isothiazolone (4 ppm ai) followed within one hour by BrMEH (10 ppm, as total Cl₂) provided the best long-term and cost effective control of biofilm bacteria based on DO (dissolved oxygen) and HTR (heat transfer resistance measurements). In another study, a combination of BNPD/ISO, a synergistic blend of 5.3% 2-bromo-2-nitro-1,3-propanediol and 2.6% isothiazolones, was studied as a replacement for gaseous chlorine. (L. G. Kleina, et. al., “Performance and Monitoring of a New Nonoxidizing Biocide: The Study of BNPD/ISO and ATP,” paper no. 403, Corrosion/97, NACE International, Houston, Tex., 1997.) A field trial in a refinery cooling tower (140,000 gallon capacity) indicated that 65 mg/L applied twice per week provided better control of biofilm bacteria than 0.2 to 0.6 mg/L free continuous chlorine. Biofilm counts were determined by ATP measurements. About 50 mg/L product provided equivalent performance to the chlorine system (1.0×10⁴ RLU/cm²).

Certain surfactants or biodispersants have been applied to cooling water systems to help loosen up deposits arising from buildup of scales, microorganisms, and fouling materials (clay, iron, etc.). Such surfactants typically have been used in combination with certain biocides. Surfactants have been considered for both biofilm prevention and removal.

Certain nonionic surfactants, for example, were shown to reduce bacterial colonization of 316 SS coupons. (W. K. Whitekettle, “Effects of Surface-Active Chemicals on Microbial Adhesion,” Journal of Industrial Microbiology, vol. 7, pp. 105-166 (1991)). Tests indicated 2-3 log reductions in bacterial populations over a 4-day period at continuous surfactant dosages of 10 ppm. The best surfactants provided a high reduction in surface tension (>20 mN/m).

Studies of the effect of EO/PO block copolymer on film fill fouling indicate the surfactant alone was not able to provide long term control. (R. M. Donlan, D. L. Elliott, and D. L. Gibbon, “Use of Surfactants to Control Silt and Biofilm Deposition onto PVC Fill in Cooling Water Systems,” IWC-97-73, Engineers' Society of Western Pennsylvania, Pittsburgh, Pa., 1997.) Continuous addition of 250 ppm block copolymer in a model recirculating water system reduced bacterial colonization for 14 days but little effectiveness was observed after 35 days. A combination of EO/PO (50 mg/L) together with slug doses of glutaraldehyde (60 mg/L, 3×/week) reduced solids accumulation significantly relative to controls with no biocide or surfactant treatment.

Use of a proprietary anionic biodetergent (linear alkylbenzenesulfonate, applied at 5 ppm) together with normal activated sodium bromide treatment removed resulted in a gradual removal of deposits on film fill surfaces. (F. P. Yu, et al., “Cooling Tower Fill Fouling Control in a Geothermal Power Plant,” paper no. 529, Corrosion/98, NACE International, Houston, Tex., 1998.) This treatment also restored cooling tower operating efficiency which was gradually eroded under the previous biodispersant program

An improved biodetergent has been developed which consists of an alkyl polyglycoside (APG) containing C₈ to C₁₆ alkyl groups. (F. P. Yu, et al., “Innovations in Fill Fouling Control,” IWC-00-03, Engineers' Society of Western Pennsylvania, Pittsburgh, Pa., 2000.) The product is reported to possess” . . . both dispersancy (dispersing aggregates) in the bulk water and detergency (removing biofilm matrix) in the solid/liquidinterphase.” One case study in a coal-fired power plant indicated that daily slug doses of 20 ppm APG with activated sodium bromide (0.5 ppm free) provided immediate increases in levels of protein and ATP in the bulk water and dramatic improvements in cooling tower thermal efficiency relative to the activated bromide-only treatment. A second study in a different coal-fired plant indicates that continuous dosages of 20 ppm APG together with BCDMH (0.1-0.2 ppm) gradually led to reduced biomass accumulations on test coupons.

2-(Decylthio)ethanamine (DTEA) is a product that is offered as both a biocide and biodispersant. Several case studies of DTEA which indicated removal of slimes and biofouling deposits have been described. (A. G. Relenyi, “DTEA: A New Biocide and Biofilm Agent,” presented at AWT Annual Meeting, Colorado Springs, Colo., 1996.) For example, biofilm that was plugging nozzles on a distribution deck was removed following three doses of DTEA (15 ppm active) on alternate days together with low chlorine residuals. Additional studies indicate control of biofilm with twice weekly slug dosages of DTEA (20 ppm active) as indicated by ATP and biofilm thickness measurements. The product also controls biofouling of film-fill where its performance was attributed to disruption of biofilm via chelation of Ca scale. The general recommendation for open loop systems is to apply 1 to 25 ppm DTEA as active 2 to 3× per week. The product is also said to be a good algaecide.

A formulation that forms a film on surfaces to inhibit corrosion, disperse slimes, scales, and algae, and control macrofouling has been discussed. (R. T Kreuser, et al., “A Novel Molluscide, Corrosion Inhibitor, and Dispersant,” paper no. 409, Corrosion/97, NACE International, Houston, Tex., 1997.) One field study involved a hotel complex which used harbor water for cooling. The system had severe fouling problems, reduced heat transfer and plugged tubes. Treatment with film forming formulation (6 mg/L) for one hour daily resulted in a reduction of black, slimy deposits in the tubular heat exchangers after one week and complete removal of the deposits after one month of application.

Use of enzymes can be considered an emerging technology. Enzymes are proteins isolated from living organisms—plants, animals, microorganisms—that speed up certain chemical reactions. Certain enzymes such as acidic and alkaline proteases, carbohydrases (e.g., amylases), and esterases (e.g., lipases) accelerate the hydrolysis of organic compounds. These enzymes have been used to help prevent or remove the outer slime layer (EPS) of biofilm deposits.

A review of the use of enzymes to control slimes, biofouling and MIC appeared several years ago. (R. W. Lutey, “Enzyme Technology: A Tool for the Prevention and Mitigation of Microbiologically Influenced Corrosion,” IWC-97-71, Engineers' Society of Western Pennsylvania, Pittsburgh, Pa., 1997.) One suggested method for removing accumulated layers of sessile biomass involves a multi-step process involving addition of one amylase, one acidic/alkaline protease, and an anionic surfactant. Tests on slime forming organisms isolated from paper machine deposits indicate that the use of this enzyme formulation (each component added at 20 ppm) significantly reduced pressure drop in a fouled stainless steel tube. The enzyme combination apparently hydrolyzes the EPS associated with the biomass and detergent helps flush the deposit off the substrate. The appeal of this technology is that enzymes are relatively non-toxic and are of natural origin. However, this approach still remains to be proven as general and cost effective method for biofouling control.

Despite intensive research studies such as those referred to above, it would be of considerable advantage if away could be found of achieving still more effective and/or longer lasting eradication or control of biofilm in water systems, such as industrial and waste water systems, and especially biofilms harboring pathogenic species.

### THE PRESENT INVENTION

Pursuant to this invention the effectiveness of certain highly effective biocides is potentiated by use of a biodispersant therewith. It is believed that the biodispersants used facilitate penetration of the defensive polysaccharide shields or layers of the biofilm by the biocidal species released in the water by the highly effective biocides used in the practice of this invention. In this way the biocidal species can exert their devastating effects upon the active biofilm and pathogen species within the heart of the normally penetration-resistant biomass. And since in many cases the rate of penetration by the biocidal species is relatively rapid, their biocidal activities within the biomass tend to be longer lasting.

The biocides used in the practice of this invention are one or more bromine based-biocides comprising (i) a sulfamate-stabilized, bromine-based biocide or (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii). Of these biocides, sulfamate-stabilized, bromine-based biocides, especially a sulfamate-stabilized bromine chloride solution are preferred. Aqueous solutions comprised of one or more active bromine species, said species resulting from a reaction in water between bromine, chlorine, or bromine chloride, or any two or all three there of are particularly preferred when used in combination with a biodispersant pursuant to this invention. Such aqueous solutions of bromine species and biodispersant possess the advantageous property of effectively coordinating rate of penetration and rate of kill of biofilm such that the biocidal activity of the solution is not prematurely lost or severely depleted during the penetration of the protective polysaccharide films generated by the biofilm pathogens.

Thus, in the practice of this invention highly effective results can be achieved by use of a bromine-based microbiocide comprising an aqueous microbiocidal solution comprised of one or more active bromine species, said species resulting from a reaction in water between bromine, chlorine, or bromine chloride, or any two or all three thereof, and a water-soluble source of sulfamate anion, especially where the molar ratio of bromine to chlorine is equal to or greater than 1. Such water solutions are usually provided as a concentrated solution which may contain at least 50,000 ppm (w/w), preferably at least 100,000 ppm (w/w) of active bromine, and still more preferably at least 160,000 ppm (w/w) of active bromine. When used by addition to a body of water in contact with biofilm, or that comes into contact with biofilm, such concentrated solutions or partially diluted solutions formed therefrom are added to or otherwise introduced into the body of water to provide a microbiocidally effective amount of active bromine therein. When used by application to a surface such by use of an applicator (mop, cloth, etc.) the concentrate can if necessary be used as received. However usually the concentrate will be diluted before such application.

An aqueous microbiocidal solution of at least one 1,3-dibromo-5,5-dialkylhydantoin in which each of the alkyl groups, independently, contains in the range of 1 to about 4 carbon atoms, the total number of carbon atoms in these two alkyl groups not exceeding 6 can also be effectively used in the practice of this invention. Such aqueous solutions are typically formed by dissolving a suitable quantity of the 1,3-dibromo-5,5-dialkylhydantoin in water to form a solution containing a microbiocidally effective amount of active bromine therein.

Water-soluble 1,3-dibromo-5,5-dialkylhydantoins utilized in the practice of this invention comprise 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, 1,3-dibromo-5,5-diethylhydantoin, and the like. Mixtures of any two or more of these can be used. Of these biocidal agents, 1,3-dibromo-5-isobutyl-5-methylhydantoin, 1,3-dibromo-5-n-propyl-5-methylhydantoin, and 1,3-dibromo-5-ethyl-5-methylhydantoin are, respectively, preferred, more preferred, and even more preferred members of this group from the cost effectiveness standpoint. Of the mixtures of these biocides that can be used pursuant to this invention, it is preferred to use 1,3-dibromo-5,5-dimethylhydantoin as one of the components, with a mixture of 1,3-dibromo-5,5-dimethylhydantoin and 1,3-dibromo-5-ethyl-5-methylhydantoin being particularly preferred. The most preferred biocide employed in the practice of this invention is 1,3-dibromo-5,5-dimethylhydantoin.

A method for preparing bromine-based biocides of type (i) is described in U.S. Pat. No. 6,068,861. A preferred bromine-based biocide of type (i) in the form of a concentrated aqueous solution with an alkaline pH is available in the marketplace under the trade designation STABROM® 909 biocide (Albemarle Corporation). Thus by “sulfamate-stabilized bromine chloride” is meant a product such as STABROM® 909 biocide or that can be formed for example by the inventive processes described in U.S. Pat. No. 6,068,861. Bromine-based biocides of type (ii) typically exist as particulate solids, and methods for preparing them are described in the literature. The most preferred bromine-based biocide of type (ii), namely 1,3-dibromo-5,5-dimethylhydantoin, in the form of easy-to-use granules is available in the marketplace from Albemarle Corporation under the trade designation XtraBrom™ 111 biocide.

The powerful activity of these preferred biocides in challenging or eradicating biofilm was demonstrated in a group of comparative tests. In these tests, a wide range of biocides used in both industrial and recreational water treatment towards biofilms comprised of Pseudomonas aeruginosa.

The tests were performed at MBEC Biofilm Technologies, Inc., Calgary, Canada. The test procedure, developed at the University of Calgary, utilizes a device which allows the growth of 96 identical biofilms under carefully controlled conditions. The device consists of a two-part vessel comprised of an upper plate containing 96 pegs that seals against a bottom plate. The bottom plate can consist of either a trough (for biofilm growth) or a standard 96-well plate (for biocide challenge). The biofilms develop on the 96 pegs. The device has been used as a general method for evaluating the efficacy of antibiotics and biocides towards biofilms. See in this connection H. Ceri, et al., “The MBEC Test: A New In Vitro Assay Allowing Rapid Screening for Antibiotic Sensitivity of Biofilm”, Proceedings of the ASM, 1998, 89, 525; Ceri, et al., “Antifungal and Biocide Susceptibilitytesting of Candida Biofilms using the MBEC Device”, Proceedings of the Interscience Conference on Antimicrobial Agents and Chemotherapy, 1998, 38, 495; and H. Ceri, et al., “The CalgaryBiofilm Device: A New Technology for the Rapid Determination of Antibiotic Susceptibility of Bacterial Biofilms”, Journal of Clinical Microbiology, 1999, 37, 1771-1776.

Thirteen biocide systems were evaluated using the above test procedure and test equipment. Six of these systems were oxidizing biocides, viz., chlorine (from NaOCl), halogen (from NaOCl+NaBr), bromine (from sulfamate-stabilized bromine chloride), bromine (from DBDMH), halogen (from BCDMH), and chlorine (from trichloroisocyanuric acid) (Trichlor), all expressed as Cl₂ in mg/L, so that all test results were placed on the same basis. The other biocides tested were glutaraldehyde, isothiazolone, (2-decylthio)ethanamine (DTEA), peracetic acid, hydrogen peroxide, poly(oxyethylene(dimethyliminio)ethylene-(dimethylio)ethylenedichloride) (Polyquat), and dibromonitrilopropionamide (DBPNA). These other biocides are all expressed as mg/L of active ingredient.

These biocide systems were used to challenge biofilms of Pseudomonas aeruginosa (ATCC 15442). This is a Gram (−) bacterium which is ubiquitous in microbiological slimes found in industrial and recreational water systems. See in this connection J. W. Costerton and H. Anwar, “Pseudomonas aeruginosa: The Microbe and Pathogen”, in Pseudomonas aeruginosa Infections and Treatment, A. L. Baltch and R. P. Smith editors, Marcel Dekker publishers, New York, 1994. Tests were performed using 1-day old biofilm and 7-day old biofilm.

In Table 1 the MBEC (minimum biofilm eradication concentration) results presented are for the one-hour biocide contact time used in the tests (except as otherwise noted). The values given for the halogen containing biocides are expressed in terms of chlorine as Cl₂ mg/L as active ingredient. The data indicate that the DBDMH used pursuant to this invention was more effective than any of the other biocides tested under these conditions with an MBEC of 1.4 mg/L of chlorine, as Cl₂. In fact, only slightly more than one-half as much total halogen residual from DBDMH was required to remove the bio film as compared to the total residual halogen, expressed as Cl₂, that was required from BCDMH.

Table 1 summarizes these test results. The abbreviations or designations used in the Table are as follows: SSBC—stabilized bromine chloride;
DBDMH—1-3-dibromo-5,5-dimethylhydantoin;
BCDMH—1-bromo-3-chloro-5,5-dimethylhydantoin;
Trichlor—1,3,5-trichloroisocyanuric acid;
Isothiazolone—5-chloro-2-methyl-4-isothiazolin-3-one/2-methyl-4-isothiazolin-3-one mixture;
DTEA—decylthioethaneamine hydrochloride,
Polyquat—poly(oxyethylene(dimethyliminio)ethylene(dimethyliminio)ethylenedichloride);

DBNPA—Dibromonitrilopropionamide.

TABLE 1
Minimum Biofilm Eradication Concentration (MBEC)
for Selected Biocide Systems
(One Hour Contact Time)

| Biocide | 1-Day Biofilm | | 7-Day Biofilm | |
|---|---|---|---|---|
| System | MBEC, ppm | MBEC, avg. | MBEC, ppm | MBEC, avg. |
| Bleach | 5.0, 2.5 | 3.8 | 20, 20 | 20 |
| (NaOCl) | | | | |
| Activated NaBr | 2.5, 2.5 | 2.5 | 5, 10 | 7.5 |
| (NaOCl + | | | | |
| NaBr) | | | | |
| SSBC | 2.5, 5 | 3.8 | 5, 5 | 5 |
| DBDMH | 1.2 | 1.2 | 5, 5 | 5 |
| BCDMH | 2.5, 2.5 | 2.5 | 5, 10 | 7.5 |
| Trichlor | 2.5, 1.2 | 1.9 | 20, 20 | 20 |
| Glutaraldehyde | 50, 50 | 50 | 100, >200 | 200 |
| | | | | (est.) |
| Isothiazolone | 50, 100 | 75 | — | — |
| DTEA | 100, 100 | 100 | — | — |
| Peracetic Acid | 100, >100 | 150 | — | — |
| (1) | | (est.) | | |
| H₂O₂ (1) | >100, >100 | >200 | — | — |
| | | (est) | | |
| Polyquat | >400, >400 | >400 | — | — |
| DBNPA | 2.0, 4.1 | 3.1 | — | — |

(1) Four-hour contact time.

It will be seen from Table 1 that especially in the tests against older, more mature biofilms the bromine-based biocides of this invention were very effective. It is known that as bio films age they can become more resistant to biocide treatment. See in this connection P. S. Stewart, “Biofilm Accumulation Model that Predicts Antibiotic Resistance of Pseudomonas aeruginosa Bio films,” Antimicrobial Agents and Chemotherapy, p. 1052, May, 1994.

Additional tests were conducted on SSBC and DBDMH, as well as bromine from activated sodium bromide (a product formed from NaOCl and NaBr) using a laboratory model water system described by E. McCall, J. E. Stout, V. L. Yu, and R. Vidic, “Efficacy of Biofilms Against Biofilm-Associated Legionella in a Model System,” International Water Conference, paper no. IWC-99-70, Engineers' Society of Western Pennsylvania, Pittsburgh, Pa. In these short-term tests all three biocides proved effective against biofilm-associated Legionella with initial 3 to 3.8 log reductions in bacteria counts. The biocides also controlled Planktonic Legionella with initial reductions of 3.6 to 4 log units. The results of these tests are summarized in Table 2.

TABLE 2

| | | |
|---|---|---|
| | Log Reduction, | Log Reduction, |
| Residual, | Legionella² | HPC Bacteria² |

| Biocide¹ | Max. as Cl₂ | Planktonic | Biofilm | Planktonic | Biofilm |
|---|---|---|---|---|---|
| SBC | 4.1 | 3.9 | 3 | 2.2 | 2.2 |
| DBDMH | 1.9 | 3.6 | 3.6 | 3.6 | 2.7 |
| Act. | 1.7 | 3.8 | 3.8 | 3.4 | 3.7 |
| NaBr¹ | | | | | |

¹SBC = stabilized bromine chloride; DBDMH = dibromodimethylhydantoin; Activated NaBr = NaOCl + NaBr.
²Maximum log reductions were typically obtained at 2-12 hours after biocide application.

As is well known, bacteria can repopulate to pre-biocide levels after removal of the biocide or “stress”. The above tests not only monitored the activity of the biocides to control bacteria initially but over the long-term as well. Long-term control was simulated by flushing the remaining biocide out of the system after the 48-hour biocide challenge period and then refilling the system with sterile chlorine-free water. Microbial populations were then monitored over a two-week recovery period. This work uncovered significant differences between the biocides of this invention and the comparative biocide towards long-term control of bacteria. These test results are summarized in Table 3.

TABLE 3

| | Log Reduction, Legionella¹ | | Log Reduction, HPC Bacteria¹ | |
|---|---|---|---|---|
| Biocide | Planktonic | Biofilm | Planktonic | Biofilm |
| SBC | 3.7 | 1.8 | 1.4 | 0.8 |
| DBDMH | 1.7 | 1.5 | 0.2 | 0.4 |
| Act. NaBr | −0.1 | 0.1 | 0.2 | 0.3 |

¹Log reductions relative to control after the 14-day recovery period.

Both SBC and DBDMH maintained long-lasting control of bacteria in both the biofilm and planktonic phases. At the conclusion of the 14-day recovery period, for example, biofilm-associated Legionella counts remained 1.5 to 1.8 log units lower than the untreated values. Good control of planktonic Legionella was also observed with these biocides.

In addition to improved biocidal effectiveness, this invention provides a combination of additional advantages. For example, 1,3-dibromo-5,5-dimethylhydantoin (DBDMH) in combination with a conventional biodispersant package, has been found to provide superior performance at a lower rate of consumption than N,N′-bromochloro-5,5-dimethylhydantoin (BCDMH) when used with the same conventional biodispersant package. In addition, the DBDMH/biodispersant package exhibited a much faster development of target halogen residuals which could not be achieved with the BCDMH/biodispersant package. Further, it was observed that the visual water depth in the basin of the cooling tower was increased from 10-12 inches to more than 23 inches by use of the DBDMH/biodispersant package. These tests were performed in a twin cell, counterflow cooling tower having a 200,000 gallon capacity and it was found that the rate of consumption was reduced by about ⅓ by use of DBDMH/biodispersant package as compared to BCDMH/biodispersant package. The biodispersant package used contained a proprietary biodispersant, and in addition 1-hydroxyethane-1,1-diphosphonic acid (HEDP), 2-phosphonobutane-1,2,4-tricarboxylic acid(PBTC), tolyltriazole (TT), and sodiummolybdate. The materials of construction of the cooling tower system consisted of a wood tower, concrete basin, copper heat exchangers and mild steel piping. It was found that the corrosion rates of both mild steel and of copper were significantly reduced by use of the DBDMH/biodispersant package as compared to the BCDMH/biodispersant package. In particular, on mild steel the rate of corrosion after a five week exposure using the BCDMH/biodispersant package was 3.6 mils per year whereas after a six week exposure using the DBDMH/biodispersant package, this rate of corrosion was a mere 1.2 mils per year. In the case of copper corrosion, the rates of corrosion were 0.06 mils per year with the BCDMH/biodispersant package in a five week exposure period, and 0.05 mils per year with the DBDMH/biodispersant package in a six week exposure period.

Effective biodispersants used in the practice of this invention can be selected from various types of surfactants, including anionic, nonionic, cationic, and amphoteric surfactants. A number of suitably effective surfactants for this use are available in the marketplace. A few non-limiting examples of anionic surfactants deemed suitable for the practice of this invention include such surfactants as (a) one or more linear alkyl benzene sulfonates in which the alkyl group has in the range of about 8 to about 16 carbon atoms, (b) one or more alkane sulfonates having in the range of about 8 to about 16 carbon atoms in the molecule, (c) one or more alpha-olefin sulfonates having in the range of about 8 to about 16 carbon atoms in the molecule, and one or more diaryl disulfonates in which the aryl groups each contain in the range of 6 to about 10 carbon atoms. Mixtures of any two or three or all four of (a), (b), (c), and (d) can be used. The cation of such sulfonates is typically sodium, but sulfonates with other suitable cations such as the ammonium or potassium cations are suitable. Surfactants of the above types are available commercially from a number of sources, and methods for their preparation are described in the literature.

Non-limiting examples of nonionic surfactants deemed suitable for the practice of this invention include such surfactants as (a) one or more alkyl polyglycosides in which the alkyl group contains in the range of about 8 to about 16 carbon atoms and the molecule contains in the range of 2 to about 5 glycoside rings in the molecule and (b) one or more block copolymers having repeating ethylene oxide and repeating propylene oxide groups in the molecule. Mixtures of (a) and (b) can be used. Various alkyl polyglycosides of (a) are available commercially and are described for example in U.S. Pat. No. 6,080,323. Similarly, block copolymers of (b) are available commercially, and are described and identified for example in U.S. Pat. No. 6,039,965. The block copolymers of (b) are expected to function in this invention at least primarily by weakening the bonding between the biofilm infestation and the substrate surface to which the biofilm is attached, although they may assist somewhat in improving penetration of the active bromine through the protective polysaccharides and into the biofilm infestation.

Another group of biodispersant(s) for use in the practice of this invention are nitrogen-containing surfactants some of which are amphoteric or cationic surfactants, especially amines and amine derivatives having surfactant properties. One group of preferred compounds are alkylthioethanamine carbamic acid derivatives such as are described in U.S. Pat. Nos. 4,816,061, 5,118,534, and 5,155,131. Of these carbamic acid derivatives those in which the alkylthio group has about 7 to about 11 carbon atoms are preferred, those in which the alkylthio group has 8 to 11 carbon atoms are more preferred, with 2-(decylthio)ethanamine being particularly preferred. Another group of suitable amine-based surfactants are alkyldimethylamines, alkyldiethylamines, alkyldi(hydroxyethyl)amines, alkyldimethylamine oxides, alkyldiethylamine oxides, and alkyldi(hydroxyethyl) amine oxides in which the alkyl group contains in the range of about 8 to about 16 carbon atoms. Still other suitable nitrogen-containing compounds for this use include alkylguanidine salts such as dodecyl guanidine hydrochloride or tetradecylguanidine hydrochloride, and tallow hydroxyethyl imidazoline. Mixtures of the same and/or of different types of these nitrogen-containing surfactants can be used.

Among preferred surfactants for use in the practice of this invention are alpha-olefin sulfonates, internal olefin sulfonates, paraffin sulfonates, aliphatic carboxylates, aliphatic phosphonates, aliphatic nitrates, and alkyl sulfates, which have an HLB of 14 or above. Examples of such surfactant types can be found in Mcutcheon's Emulsifiers and Detergents, North American Edition, and International Edition, 1998 Annuals. In situations where the HLB of a given candidate for use as component (ii) is not already specified, the HLB can be calculated using the method described by J. T. Davies, Proc. 2nd Int. Congr. Surf. Act., London, Volume 1, page 426. Also see P. Becher, Surfactants in Solution, Volume 3, K. L. Mittal, Ed., Plenum, New York, 1984; J. Disp. Sci. & Tech., 1984, 5, 81. It will be noted that surfactants meeting the HLB requirement of 14 or above have relatively small molecular structures as compared to surfactants widely-used for laundry applications. A few additional non-limiting examples of these preferred surfactants are 1-hexene sulfonate, 1-octene sulfonate, and C₈ paraffin sulfonate. The first two of these can be prepared by direct sulfonation of 1-hexene and 1-octene, respectively, followed by deoiling. The paraffin sulfonate (e.g., a mixture of 52% mono-sulfonate and 48% of disulfonate) can be prepared using bisulfite addition of 1-octene, followed by oxidation and deoiling.

Other types of biodispersants can be used, especially biodispersants which are in the liquid state or formulated to be in the liquid state. Such liquids are readily blended with biocidal solutions of sulfamate-stabilized, bromine-based biocide and/or biocidal solutions formed from 1,3-dibromo-5,5-dialkylhydantoin in which each of the alkyl groups, independently, contains in the range of 1 to about 4 carbon atoms, the total number of carbon atoms in these two alkyl groups not exceeding 6.

The concentrations of the bromine-based biocide and the biodispersant(s) in the aqueous medium in contact with, or that comes into contact with, the biofilm can be varied within wide limits. Such concentrations and relative proportions can depend on such various factors as the identity of the biodispers ant or biodispersants being used, the type and severity of the biofilm infestation, the nature of any pathogens contained within the biofilm infestation, and the like. As a general proposition, the amount of the bromine-based biocide used should be an effective microbiocidal amount, i.e., an amount that when acting in combination with the biodispersant(s) used is effective to eradicate or at least substantially eradicate the biofilm and the pathogens, if any, present therein, and the amount of the biodispersant(s) used with the biocide should be an effective potentiating amount, i.e., an amount that is effective to improve the microbiocidal effectiveness of the biocide. Typically, the concentrations of active bromine and of the biodispersant in the aqueous medium in contact with or that comes into contact with the biofilm are, respectively, a microbiocidally-effective amount of active bromine that is at least 0.1 ppm (w/w), and an effective potentiating amount of at least 1 ppm (w/w) of the biodispersant(s). Preferred concentrations are in the range of about 0.2 to about 10 ppm (w/w) of active bromine and in the range of about 2 to about 50 ppm (w/w) of the biodispersant(s). More preferred concentrations are in the range of about 0.4 to about 4 ppm (w/w) of active bromine and in the range of about 5 to about 25 ppm (w/w) of the biodispersant. Departures from these concentrations can be used whenever deemed necessary or desirable without departing from the scope of this invention. As noted above, the mechanism by which the potentiation of this invention occurs is believed to involve, in part if not in whole, the biodispersant(s) facilitating penetration of the aqueous active bromine into the active center(s) or core of the biofilm colony. It is also possible that the biodispersant weakens the bonding between the biofilm infestation and the substrate surface to which the biofilm is attached.

To determine the amount of active bromine in the water in the low ranges of concentrations described in the immediately preceding paragraph, the well-known DPD “total chlorine” test, should be used. While originally designed for analyzing relatively dilute chlorine-containing solutions, the procedure is readily adapted for use in determining active bromine contents of relatively dilute solutions as well. In conducting the test the following equipment and procedure are recommended:
1. The water sample should be analyzed within a few minutes of being taken, and preferably immediately upon being taken.
2. Hach Method 8167 for testing the amount of species present in the water sample which respond to the “total chlorine” test involves use of the Hach Model DR 2010 calorimeter. The stored program number for chlorine determinations is recalled by keying in “80” on the keyboard, followed by setting the absorbance wavelength to 530 nm by rotating the dial on the side of the instrument. Two identical sample cells are filled to the 10 mL mark with the water under investigation. One of the cells is arbitrarily chosen to be the blank. To the second cell, the contents of a DPD Total Chlorine Powder Pillow are added. This is shaken for 10-20 seconds to mix, as the development of a pink-red color indicates the presence of species in the water which respond positively to the DPD “total chlorine” test reagent. On the keypad, the SHIFT TIMER keys are depressed to commence a three minute reaction time. After three minutes the instrument beeps to signal the reaction is complete. Using the 10 mL cell riser, the blank sample cell is admitted to the sample compartment of the Hach Model DR 2010, and the shield is closed to prevent stray light effects. Then the ZERO key is depressed. After a few seconds, the display registers 0.00 mg/L Cl₂. Then, the blank sample cell used to zero the instrument is removed from the cell compartment of the Hach Model DR 2010 and replaced with the test sample to which the DPD “total chlorine” test reagent was added. The light shield is then closed as was done for the blank, and the READ key is depressed. The result, in mg/L Cl₂ is shown on the display within a few seconds. This is the “total chlorine” level of the water sample under investigation.
3. To convert the result into mg/L active Br₂, the result is multiplied by 2.25.

Frequency of dosage can also vary depending upon such factors as the type and severity of the biofilm infestation, the nature of any pathogens contained with in the biofilm infestation, the local climate conditions such as extent of direct exposure to sunlight, or the like. Generally speaking, one should dose the water system with sufficient frequency to ensure that effective substantially continuous control or eradication of biofilm is accomplished. For example, under typical conditions the water system should be dosed at intervals in the range of 2 to 7 days and preferably in the range of 1 to 3 days.

It is possible pursuant to this invention to form aqueous concentrates of the active bromine-containing biocides of this invention together with an appropriate proportion of the biodispersant(s). In such cases the weight ratios as between the active bromine and the biodispersant should correspond to those set forth above in connection with the diluted water systems, except of course that the actual amounts of these components in the aqueous concentrate will be substantially higher. For example, a concentrate containing, say, 50,000 to 120,000 ppm of active bromine (w/w) will typically contain in the range of 1,000 to 100,000 ppm of biodispersant(s), and preferably in the range of 10,000 to 50,000 ppm of biodispersant(s).

Water systems that can be treated pursuant to this invention to eliminate or at least control biofilm infestations include commercial and industrial recirculating cooling water systems, industrial once-through cooling water systems, pulp and paper mill systems, air washer systems, air and gas scrubber systems, wastewater, and decorative fountains.

A few non-limiting illustrations of embodiments of this invention include the following:
1) A method of potentiating the effectiveness of a bromine-based microbiocide in combating formation of biofilm infestation and/or growth of biofilm on a surface, which method comprises contacting the biofilm or the surface on which biofilm infests with an aqueous medium to which have been added (a) a sulfamate-stabilized bromine chloride solution or (b) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (a) and (b), and (c) at least one biodispersant.
2) A method of potentiating the effectiveness of a bromine-based microbiocide when in an aqueous medium contact with biofilm, or which comes into contact with biofilm, which method comprises providing in or adding to said aqueous medium a microbiocidally effective amount of (a) sulfamate-stabilized bromine chloride solution or (b) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (a) and (b), and (c) at least one biodispersant.
3) A method of eradicating or at least controlling biofilm in contact with an aqueous medium that is in contact with the biofilm or which comes into contact with the biofilm, which method comprises introducing into the aqueous medium:
   A) a bromine-based microbiocide comprising (a) a sulfamate-stabilized bromine chloride solution or (b) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (a) and (b); and
   B) at least one biodispersant.
4) A method of eradicating or at least controlling biofilm in contact with an aqueous medium in contact with or which comes into contact with the biofilm, which method comprises introducing into the aqueous medium:
   A) a bromine-based microbiocide comprising (i) an aqueous microbiocidal solution comprised of one or more active bromine species, said species resulting from a reaction in water between bromine, chlorine, or bromine chloride, or any two or all three thereof, and a water-soluble source of sulfamate anion, (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii), and
   B) at least one biodispersant that potentiates the effectiveness of said one or more active bromine species.
5) A composition which comprises:
   A) a bromine-based biocide comprising (a) a sulfamate-stabilized bromine chloride solution or (b) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (a) and (b), and
   B) at least one biodispersant.
6) A method of any of 1), 2), 3), or 4), or a composition of 5) above wherein the bromine-based biocide used therein is a sulfamate-stabilized bromine chloride solution.
7) A method of any of 1), 2), 3), or 4), or a composition of 5) above wherein the bromine-based biocide used therein is at least one 1,3-dibromo-5,5-dialkylhydantoin in which each of the alkyl groups, independently, contains in the range of 1 to about 4 carbon atoms, the total number of carbon atoms in these two alkyl groups not exceeding 6.
8) A method of any of 1), 2), 3), or 4), or a composition of 5) above wherein the bromine-based biocide used therein is 1,3-dibromo-5,5-dimethylhydantoin.
   Still other embodiments are readily apparent from the foregoing description.

Components referred to anywhere herein, whether referred to in the singular or plural, are identified as they exist prior to coming into contact with another substance referred to by chemical name or chemical type (e.g., another component, solvent, etc.). It matters not what chemical changes, transformations and/or reactions, if any, take place in the resulting mixture or solution or formation as such changes, transformations and/or reactions (e.g., solvation, ionization, complex formation, or etc.) are the natural result of bringing the specified reactants and/or components together under the conditions called for pursuant to this disclosure. Even though substances, components and/or ingredients may be referred to in the present tense (“comprises”, “is”, etc.), the reference is to the substance, component or ingredient as it existed at the time just before it was first contacted, blended or mixed with one or more other substances, components and/or ingredients in accordance with the present disclosure, and with the application of common sense.

Each and every patent or other publication referred to in any portion of this specification is incorporated in toto into this disclosure by reference, as if fully set forth herein. To the extent, if any, and only to the extent that the incorporated patent or publication is in conflict with the present description, the present description shall control.

This invention is susceptible to considerable variation in its practice. Therefore the foregoing description is not intended to limit, and should not be construed as limiting, the invention to the particular exemplifications presented hereinabove.

1. A method of potentiating the effectiveness of a bromine-based biocide in combating formation of biofilm infestation and/or growth of biofilm on a surface, which method comprises contacting the biofilm or the surface on which biofilm infests with an aqueous medium to which have been added:
A) a bromine based-biocide comprising (i) a sulfamate-stabilized, bromine-based biocide or (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii), and
B) at least one biodispersant.

2. A method according to claim 1 further comprising providing in or adding to or introducing into said aqueous medium a microbiocidally effective amount of said bromine-based biocide and said at least one biodispersant.

3. A method of eradicating or at least controlling biofilm in contact with an aqueous medium in contact with or which comes into contact with the biofilm, which method comprises introducing into the aqueous medium:
A) a bromine based-biocide comprising (i) a sulfamate-stabilized, bromine-based biocide or (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii), and
B) at least one biodispersant to potentiate the effectiveness of said bromine-based biocide.

4. A method according to claim 1 wherein the bromine-based biocide used is a sulfamate-stabilized bromine-based biocide.

5. A method according to claim 4 wherein said sulfamate-stabilized bromine-based biocide is a sulfamate-stabilized bromine chloride solution.

6. A method according to claim 4 wherein said sulfamate-stabilized bromine-based biocide is an aqueous microbiocidal solution comprised of one or more active bromine species, said species resulting from a reaction in water between bromine, chlorine, or bromine chloride, or any two or all three thereof, and a water-soluble source of sulfamate anion.

7. A method according to claim 6 wherein said aqueous microbiocidal solution has a pH of at least 10.

8. A method according to claim 1 wherein the bromine-based biocide used is at least one 1,3-dibromo-5,5-dialkylhydantoin in which each of the alkyl groups, independently, contains in the range of 1 to about 4 carbon atoms, the total number of carbon atoms in these two alkyl groups not exceeding 6.

9. A method according to claim 1 wherein the bromine-based biocide used is an aqueous microbiocidal solution comprised of one or more active bromine species, said species resulting from dissolving said at least one 1,3-dibromo-5,5-dialkylhydantoin in an aqueous medium.

10. A method according to claim 8 wherein said at least one 1,3-dibromo-5,5-dialkylhydantoin is 1,3-dibromo-5,5-dimethylhydantoin.

11. A composition which comprises:
A) a bromine based-biocide comprising (i) a sulfamate-stabilized, bromine-based biocide or (ii) at least one 1,3-dibromo-5,5-dialkylhydantoin in which each of the alkyl groups, independently, contains in the range of 1 to about 4 carbon atoms, the total number of carbon atoms in these two alkyl groups not exceeding 6, or both of (i) and (ii), and
B) at least one biodispersant.

12. A composition according to claim 11 wherein said bromine-based biocide is a sulfamate-stabilized bromine-based biocide.

13. A composition according to claim 12 wherein said sulfamate-stabilized bromine-based biocide is a sulfamate-stabilized bromine chloride solution.

14. A composition according to claim 12 wherein said sulfamate-stabilized bromine-based biocide is an aqueous microbiocidal solution comprised of one or more active bromine species, said species resulting from a reaction in water between bromine, chlorine, or bromine chloride, or any two or all three thereof, and a water-soluble source of sulfamate anion.

15. A composition according to claim 14 wherein said aqueous microbiocidal solution has a pH of at least 10.

16. A composition according to claim 11 wherein the bromine-based biocide is at least one 1,3-dibromo-5,5-dialkylhydantoin in which each of the alkyl groups, independently, contains in the range of 1 to about 4 carbon atoms, the total number of carbon atoms in these two alkyl groups not exceeding 6.

17. A composition according to claim 11 wherein the bromine-based biocide is an aqueous microbiocidal solution comprised of one or more active bromine species, said species resulting from dissolving said at least one 1,3-dibromo-5,5-dialkylhydantoin in an aqueous medium.

18. A composition according to claim 16 wherein said at least one 1,3-dibromo-5,5-dialkylhydantoin is 1,3-dibromo-5,5-dimethylhydantoin.

19. An aqueous medium into which has been introduced a microbiocidally effective amount of a composition according to claim 11.
